(19) United States
(12) Patent Application Publication
(10) Pub. No.: US 2012/0282535 A1
(43) Pub. Date: Nov. 8, 2012

(54) FUEL CELL CHARGING SYSTEM AND METHOD OF USE

(76) Inventors: TIBOR FABIAN, MOUNTIAN VIEW, CA (US); DANIEL BRAITHWAITE, SAN FRANCISCO, CA (US)

(21) Appl. No.: 13/286,052

(22) Filed: Oct. 31, 2011

Related U.S. Application Data
(60) Provisional application No. 61/408,546, filed on Oct. 29, 2010.

(51) Int. Cl. H01M 8/04; H01M 8/06

(52) U.S. Cl. 429/421; 429/430; 429/429

(57) ABSTRACT

A system including a fuel cell system configured to produce power from a fuel and a device configured to receive the power as the power is produced. The fuel cell system includes a fuel cell arrangement fueled by a fuel supply, and a sensor configured to generate a signal indicative of available power. The device is configured to manage a device functionality to match the available power.

### CROSS-REFERENCE TO RELATED APPLICATIONS

This application claims the benefit of US Provisional Application No. 61/408,546, filed 29 Oct. 2010, which is incorporated in its entirety by this reference.

### TECHNICAL FIELD

This invention relates generally to the fuel cell field, and more specifically to a new and useful apparatus and method of charging portable devices with fuel cells.

### BACKGROUND

Over the years, there has been an increased interest in utilizing fuel cell systems to power portable consumer devices. Not only are these fuel cell systems more environmentally friendly, as measured by their carbon footprint, but they are also portable, enabling the user to recharge their portable consumer devices wherever they are located. A large barrier exists, however, in implementing fuel cell systems as power sources. Due to the inherent properties of the fuel cell system, such as the chemical nature of the fuel supply (the fuel must be generated from a reaction between at least two reactants), fuel cell systems suffer from power production lag, wherein an inadequate amount of power is initially produced until the fuel cell system “ramps up” (shown in FIG. 1). Due to the same inherent chemical properties of the fuel cell system, the fuel cell system suffers from a shut down lag as well, wherein peak power is produced as the fuel cell “ramps down” the reaction and burns off the excess produced fuel. Prior art fuel cell systems accommodate these issues by incorporating an auxiliary battery in the fuel cell system, typically after the fuel cell arrangement. However, the fuel cell arrangement is intended to be used with multiple portable electronic devices, which may have varying power requirements. In order to accommodate all these possible applications, the battery must have a capacity large enough to power the most power-intensive of the applications, leading to the incorporation of the largest requisite battery in the fuel cell system. Not only does the incorporation of this battery add volume to the fuel cell arrangement, making it bulky and unwieldy, but it also adds the complexity of voltage conversion in addition to the additional cost of the large battery and any supporting circuitry (e.g. a DC/DC circuit that converts the fuel cell output voltage to the battery input voltage) to the fuel cell system. Thus, there is a need in the fuel cell charger field to accommodate the power discrepancies between the demanded power and the fuel cell-supplied power.

### BRIEF DESCRIPTION OF THE FIGURES

FIG. 1 is a prior art schematic comparison between the power profile demanded by the device and the power profile provided by a fuel cell system.

FIG. 2 is a schematic representation of the invention.

FIG. 3 is a schematic comparison between the power profile demanded by the device controlled by the power management scheme of a preferred embodiment of the invention and the power profile provided by the power supply.

FIG. 4 is a schematic representation of the fuel cell system of the invention.

FIG. 5 is a schematic representation of a preferred embodiment of the fuel cell arrangement.

FIG. 6 is a schematic representation of a power adapter incorporating a fuel cell arrangement.

FIG. 7 is a schematic representation of an embodiment of the fuel supply.

FIG. 8 is a schematic representation of the fuel cell system including a sensor.

FIGS. 9A and 9B are schematic representations of a first and second parameter that the sensor measures.

FIG. 10 is a schematic representation of the fuel cell system receiving a signal from the device.

FIG. 11 is a schematic representation of the fuel cell system including an auxiliary battery.

FIG. 12 is a schematic representation of a power adapter including an auxiliary battery.

FIG. 13 is a schematic representation of the power management scheme for the device.

FIG. 14 is a schematic representation of an embodiment of the power management scheme.

### DESCRIPTION OF THE PREFERRED EMBODIMENTS

The following description of the preferred embodiments of the invention is not intended to limit the invention to these preferred embodiments, but rather to enable any person skilled in the art to make and use this invention.

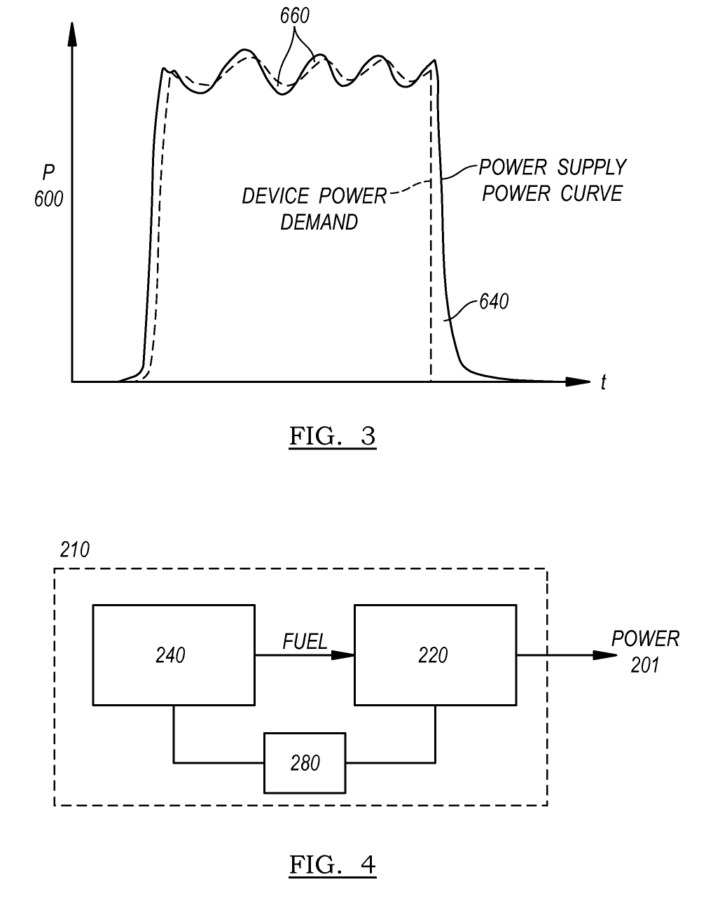

As shown in FIG. 2, the system for accommodating for power lag includes a power source 200 and a device 500, wherein the device manages the device functionalities based on the available power from the power source. Effectively, this system allows the power source to influence how, when, and what components, sequences, and programs the device can run based on the available power. In other words, this system substantially matches device consumption to the power curve of the power source, causing the device to accommodate for power production variations instead of having the power source accommodate for the power production variations (as shown in FIG. 3). This is in contrast with conventional systems, wherein the device demands a certain amount of power and the power source either succeeds or fails in meeting the demanded power; in the latter case, the device becomes substantially inoperable, even if the power source can still provide enough power for basic, low-power functionalities. By allowing the power availability to guide device operation, this system allows the device to utilize a fuel cell system as a power source, even if the device battery is drained, because the device functionality management accommodates for the start-up lag of the fuel cell system. Furthermore, this system allows for a simpler and cheaper fuel cell system, as the auxiliary battery contained in conventional fuel cell systems may be minimized or eliminated entirely.

### 1. The Power Source

As shown in FIG. 2, the power source 200 of the system functions to provide power 201 to a device. As shown in FIG. 4, the power source is preferably a fuel cell system 210 that includes a fuel cell arrangement 220 fueled by a fuel supply 240. The fuel cell system 210 may additionally include a sensor 260 that generates a signal indicative of available power 203 from the fuel cell system. However, the power source may alternatively be a battery (e.g. a rechargeable battery such as a Li-ion or Li-polymer battery), or any other suitable power source.

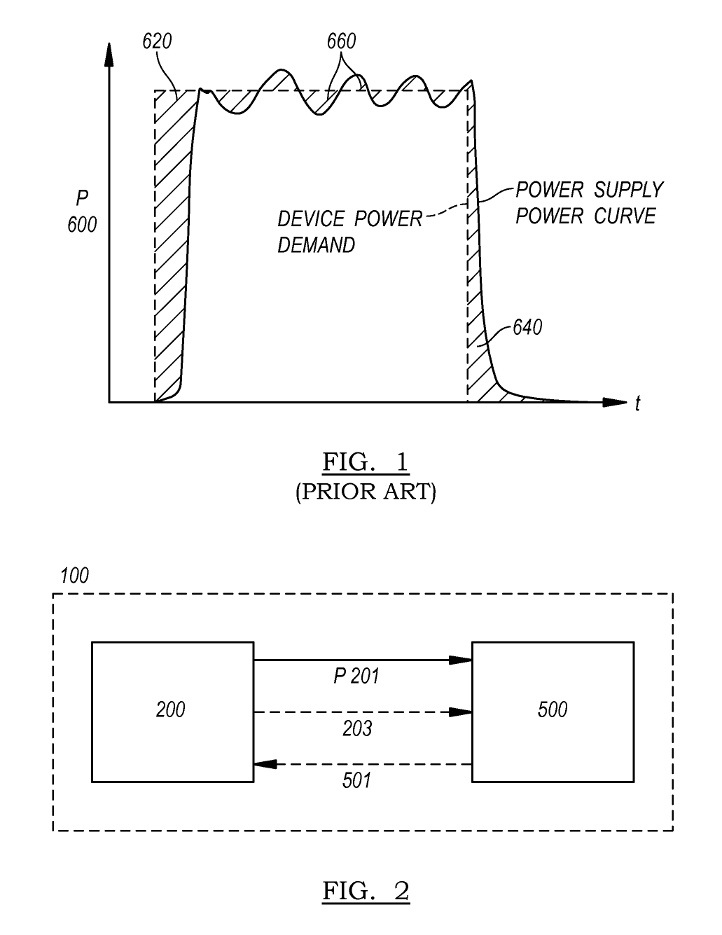

The fuel cell system 210 of the power source functions to generate DC (direct current) power. The fuel cell system is preferably a hydrogen fuel cell system, but may alternatively be any fuel cell system that utilizes any type of fuel. The fuel cell system preferably includes a fuel cell arrangement 220 fueled by a fuel supply 240. The fuel supply 240 is preferably a fuel generator that generates fuel through a chemical reaction. The fuel cell system may be similar to those systems described in U.S. application Ser. Nos. 12/501,675 and 12/803,965 (which are both incorporated in their entirety by this reference). Due to the mass and heat transfer phenomena as well as chemical nature of the fuel supply and fuel cells, the fuel cell system suffers from a starting deficit 620, ending excess 640, and operation variations 660 of produced power relative to conventional device-demanded power, as shown in FIG. 1. The starting deficit 620 occurs because the fuel supply 240 requires time to produce the fuel from a chemical reaction. While the initiation of the chemical reaction can be substantially instantaneous upon receipt of a start signal (e.g. the reactants are reacted right after a start signal, such as detection of a load on a system, is received), the provision of substantially pure, useful fuel may not be instantaneous, since time-consuming steps, such as allowing the reaction to occur and filtering the fuel out of the reaction products, must occur before fuel can be provided. Additionally, the fuel may not initially be generated at the desired rate. The power output of the fuel cell system is directly related to the rate of fuel conversion, which in turn depends on the fuel generation rate; in other words, if a high power output is desired, then a high fuel generation rate is required. However, the fuel supply, especially if it is a fuel generator, is typically unable to immediately meet this high fuel generation rate due to reaction kinetics (e.g. lower initial reaction surface area, temperature, and pressure), and must ramp up to the ideal reaction conditions for the given fuel production rate. Therefore, not only does the starting deficit 620 result from reaction-time lag, but it also results from ramp-up lag. Likewise, the ending excess 640 occurs because the fuel cell system is unable to immediately shut off energy production in the fuel supply. With respect to the fuel supply, while the additional provision of fuel-generating reactants to the reaction area can be halted upon receipt of a stop signal (e.g. detection of no load on the fuel cell system), the reactants that have already been provided to the reaction area will continue to produce fuel. Additionally, because the fuel supply is continuously producing fuel in the period between the reception of the start and stop signals, there is also fuel in the fuel supply that had been produced before receipt of the stop signal but had not yet been transferred to the fuel cell arrangement. All of this fuel is preferably eventually transferred to the fuel cell arrangement, but may alternatively be stored in the fuel supply or vented out of the fuel supply. However, because the fuel cell arrangement preferably does not store fuel, it preferably converts all of this excess fuel (in addition to the fuel already in the fuel cell arrangement when the stop signal was received) into energy, leading to an ending excess 640 of energy production. Furthermore, the fuel cell system may suffer from operation variation 660 in produced power during the operation of the power source. This operation variation 660 stems from the constantly-changing reaction kinetics of the fuel cell system, and from the actions that the fuel cell system controller 221 (FCS controller) takes to rectify the variation. For example, during the operation of the fuel supply, heat may be generated by the reaction, resulting in a faster reaction rate, a higher rate of fuel production, and more power produced, perhaps more than that demanded by the device 500. The FCS controller 221 may then compensate for the extra power production by decreasing the amount of reaction in the fuel supply 240, leading to a lower fuel production rate and less power production. While the FCS controller 221 preferably lowers the power production to that demanded by the device 500, the controller 221 may overcompensate and lower the power production below the device 500 level. Therefore, the fuel cell system may suffer from operation variation 660—both the overproduction and the underproduction of power. Other parameters of the fuel cell system that may result in operation variation include hydrogen pressure and orientation.

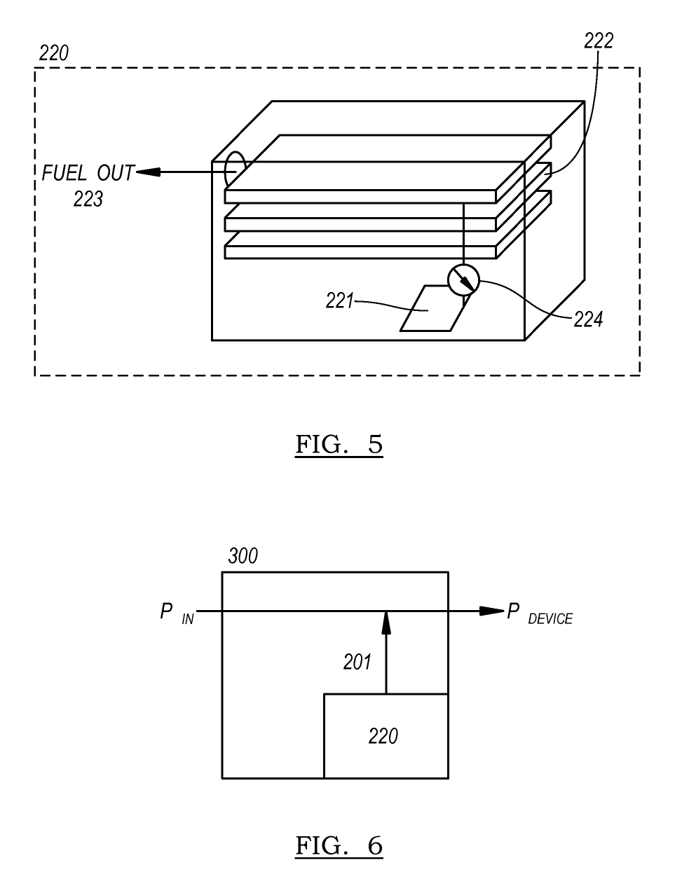

As shown in FIG. 5, the fuel cell arrangement 220 functions to convert fuel to electricity. The fuel cell arrangement 220 preferably includes one or more fuel cells, preferably arranged in a fuel cell stack coupled in series, but alternatively arranged in a fuel cell stack coupled in parallel, or a single fuel cell, or any suitable arrangement of fuel cells. The fuel cells are preferably PEM (proton exchange membrane) fuel cells, but may be high temperature fuel cells (e.g. solid oxide fuel cells, molten carbonate fuel cells), or any other suitable fuel cell. The fuel cell arrangement 220 is preferably device-specific, and may be incorporated into a device-specific power adapter (e.g. that may accept multiple power inputs, such as power from the fuel cell system 201 or power from a wall outlet, as shown in FIG. 6), may be incorporated into the device, or may be a remote fuel cell arrangement 220.

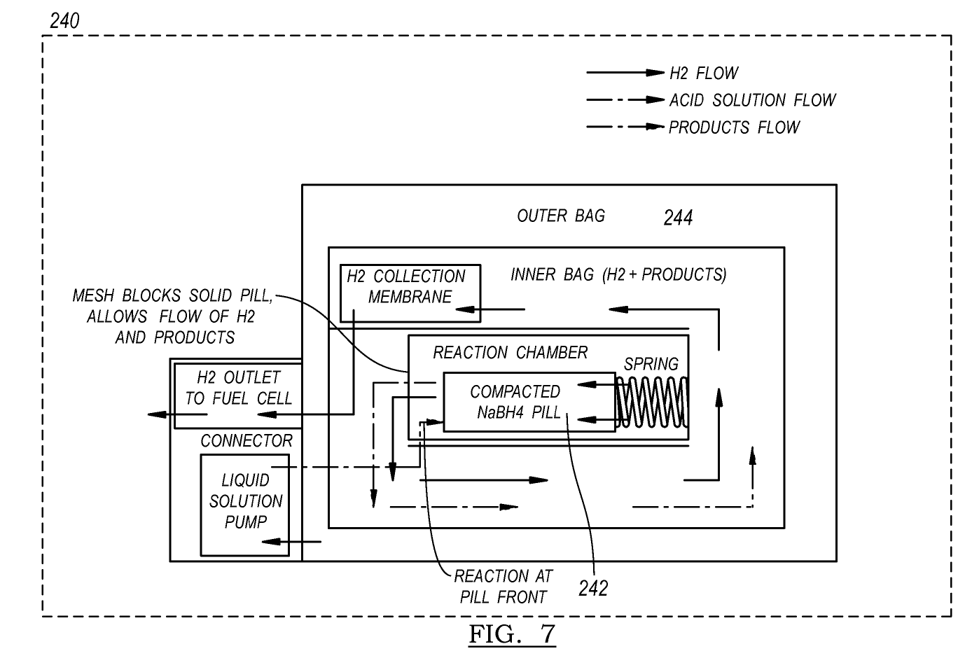

As shown in FIG. 4, the fuel supply 240 of the fuel cell system 210 functions to provide fuel to the fuel cell arrangement 220. The fuel supply 240 is preferably a fuel generator that facilitates fuel generation from a reaction between a first reactant 242 (e.g. a chemical storage moiety) and a second reactant 244. The chemical storage moiety is preferably packed into a substantially solid form (e.g. a rod or brick), and may be compartmentalized into reaction segments. As shown in FIG. 7, the fuel generator may include a first reactant 242 that includes a sodium borohydride chemical storage moiety, and a second reactant 244 that includes a liquid reactant such as water or acid. In another example, the fuel generator includes a first reactant 242 that includes an aluminum hydride chemical storage moiety (e.g. segmented into adjacent pills), wherein the second reactant 244 is heat. The fuel generator may alternatively facilitate any other means of fuel generation. The fuel generator preferably produces hydrogen gas, but may alternatively produce any suitable fuel. The fuel cell arrangement 220 is preferably fluidly coupled to the fuel supply 240 when in operation, such that fuel may flow from the fuel supply 240 to the fuel cell arrangement 220, but may or may not be fluidly coupled together when not in operation. The fuel supply 240 preferably provides fuel to the fuel cell arrangement 220 through a fluid channel, but may alternatively provide fuel to the fuel cell arrangement 220 through any suitable manner. While the pressure of the generated fuel preferably facilitates fuel flow out of the fuel supply 240, the fuel supply 240 may additionally include a pump or displacement means to facilitate fuel flow. Alternatively, the fuel supply 240 may be a fuel storage solution (e.g. a canister of compressed hydrogen gas) or any other suitable fuel supply. The fuel supply 240 preferably removably couples to the fuel cell arrangement 220 and/or the system component that integrates the fuel cell arrangement 220. The fuel supply 240 preferably couples to the fuel cell arrangement 220 through a mechanical couple (e.g. a tongue-in-groove couple, a snap-in clip, adhesive, etc.), but may alternatively couple through a magnetic couple (e.g. the fuel cell arrangement 220 includes a magnet and the fuel supply 240 includes a magnetic plate, etc.) or any other suitable coupling mechanism.

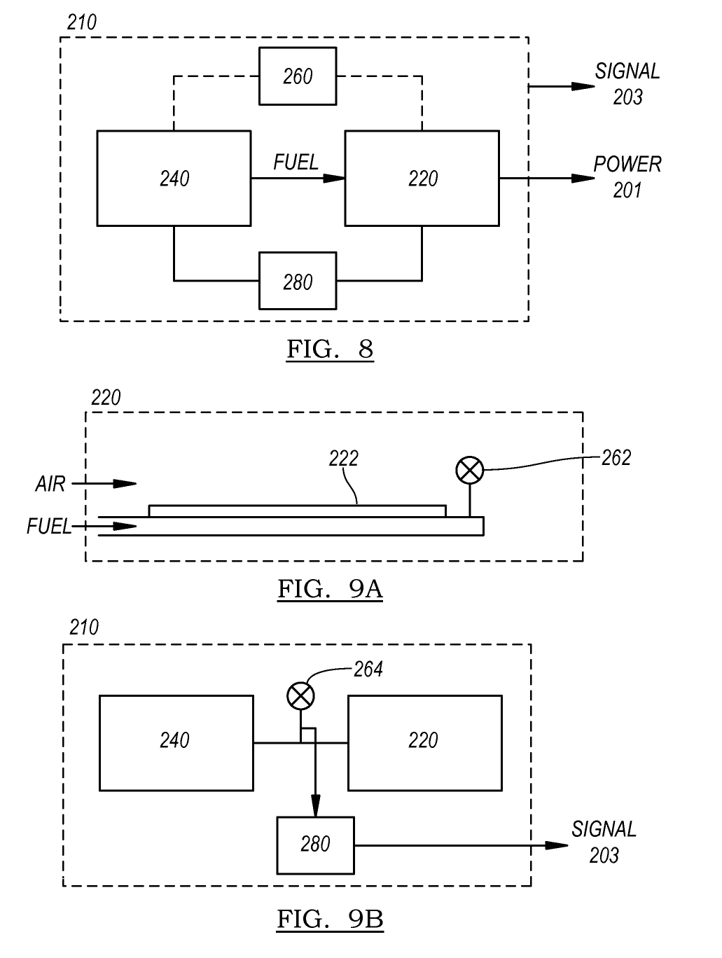

As shown in FIG. 8, the fuel cell system 210 may additionally include a sensor 260 that functions to generate a signal indicative of available power 203. The signal 203 is preferably a measurement of a fuel cell system parameter, but may alternatively be a status signal or any other suitable signal. The signal may be processed by a fuel cell system processor, or may be produced directly by the sensor 260. The measured parameter is preferably an operation parameter of the fuel cell arrangement 220, such as the dead end pressure 262 of the fuel cell arrangement (indicative of the rate of change in power production, shown in FIG. 9A), the fuel flow rate 264 of the fuel into the fuel cell arrangement 220 (shown in FIG. 9B), the produced current or power from the fuel cell arrangement 220, or any suitable parameter. The measured parameter may additionally/alternatively be an operation parameter of the fuel supply 240, such as the temperature, pressure, amount of reactant left (e.g. chemical moiety, liquid reactant, etc.), state of the reaction segment (e.g. amount consumed), flow rate out of the fuel supply, or any suitable parameter. The sensor may be a pressure sensor, temperature sensor, flow rate sensor, current sensor, volume sensor, resistor, timer, or any other suitable sensor. Alternatively, the sensor may be a monitor that combines several parameter measurements into a signal. For example, the sensor may monitor the state or condition of a chemical storage moiety segment from the amount of time the segment is held at a given temperature. The sensor may be located in the fuel cell arrangement 220, the fuel supply 240, be remote, or be located in any other suitable location.

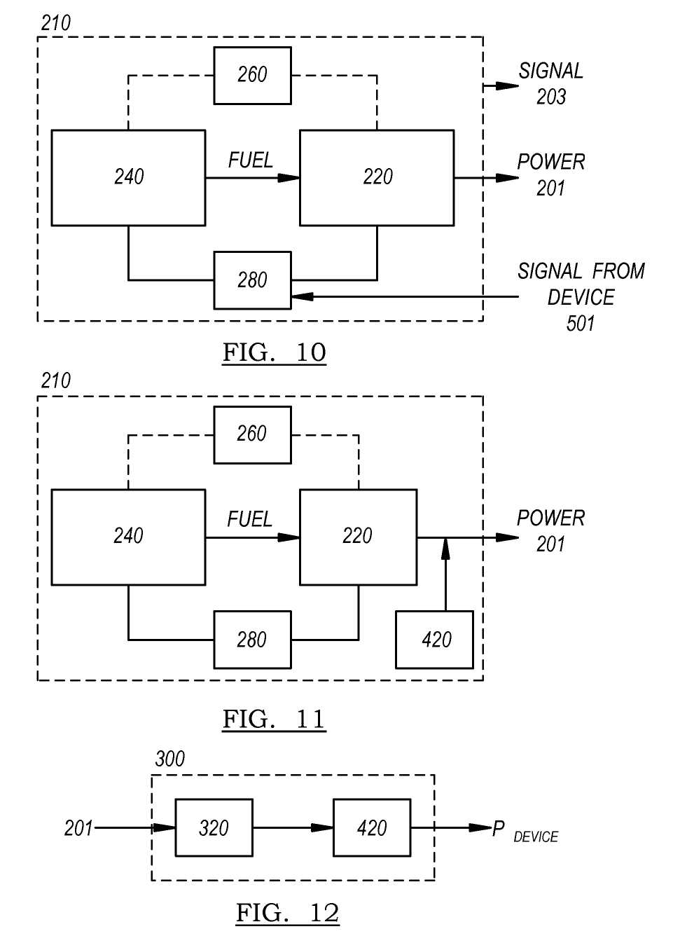

As shown in FIG. 10, the fuel cell system 210 may additionally include a processor 280 that preferably functions to control the rate of fuel generation within the fuel generator. The processor may additionally run the FCS controller 221. As shown in FIG. 2, the rate of fuel generation is preferably in response to a signal 501 received from the device 500, wherein the signal is preferably indicative of the amount of power demanded by the device, more preferably the amount of power required for full device operation. The processor may accomplish this in several ways. In a first embodiment, the processor adjusts the rate of reaction between the first and second reactants by adjusting the amount (e.g. moles, joules, etc) and/or rate the second reactant is supplied to a chemical storage moiety segment. For example, the hydrogen generation rate may be increased by increasing the amount heat applied to a segment of aluminum hydride (alane), which may be accomplished by increasing the temperature to which the alane is heated, by increasing the temperature at which the alane is heated, or by any suitable means. In a second embodiment, the processor adjusts the amount of the reactants reacted. For example, multiple segments of alane may be heated to obtain the desired fuel production rate. In a third embodiment, the processor may alter the reaction environment by adjusting the fuel generator 241 pressure, volume, temperature, or any suitable parameter. The processor may be a portion of a control system. Such control systems are known in the art, such as the control system described in U.S. application Ser. No. 12/583,925, which is incorporated in its entirety by this reference. The processor is preferably located within the fuel cell arrangement 220, but may alternatively be located within the fuel supply 240, within the device 500, or be remote.

As shown in FIG. 11, the fuel cell system 210 may additionally include a rechargeable battery 420. The battery 420 preferably functions to buffer the system against the starting deficit 620, ending excess 640, and operation variation 660 of power production. The battery 420 preferably buffers the system against the starting deficit 620 by storing enough energy and providing enough power to charge the device 500 while the fuel cell system is starting up. For this reason, the battery 420 is preferably capable of storing as much energy as the starting deficit 620; because the starting deficit 620 is the sum of the differences between power demanded and power provided over time, and the power demanded is dependent on the device 500, the battery 420 capacity is preferably tailored for the preferred device 500, but may alternatively have a large enough capacity such that it can substantially power most portable consumer electronic devices 500. The battery 420 preferably buffers the system against the ending excess 640 by storing the excess energy produced by the fuel cell system, and preferably buffers the system against operation variations by supplying and storing energy to accommodate for the underproduction and overproduction of energy, respectively. As shown in FIG. 12, the battery 420 is preferably incorporated into a power adapter 300 after a conversion circuit 320 (e.g. a DC/DC circuit), either in series or in parallel with the circuit. Because power adapters are typically device-specific, a battery 420 with a capacity just large enough to support the starting deficit 620 and ending excess 640 for the device may be used, instead of incorporating a battery 420 that is excessively large. However, the battery 420 may alternatively be incorporated into the fuel cell system, wherein an additional battery DC/DC circuit is required, or may be incorporated into the device 500, either as an auxiliary battery 420 or be the device battery 504 itself.

The fuel cell system may additionally include other mechanisms for dealing with ending excess. In one embodiment, the fuel cell system has a blow-off valve (e.g. a passive or active valve, a one-way valve, etc.), wherein excess fuel is vented into the ambient environment instead of being converted to power. In a second embodiment, the fuel cell system includes a resistive element that consumes excess power by transforming it into heat or light. However, any other suitable power- and/or fuel-consumption mechanisms may be utilized.

### 2. The Device

The device functions to buffer the system against power shortages (such as the starting deficit 620), and may additionally function to buffer the system against the ending excess 640 and/or operation variations 660. The device preferably buffers the system against power fluctuations with a power management scheme 510, which is preferably controlled by the device processor (e.g. a CPU). However, device power consumption may alternatively be controlled by any other suitable means. The device receives power from the power source, and preferably receives power as the power is produced by the fuel cell system. The device is preferably a portable consumer electronic device 500 with a processor configured to manage the device functionalities based on the available power. The device may additionally include an on-board, rechargeable battery 504, memory (e.g. disk drives), accessories, displays, ports, wireless connections (e.g. wireless LAN, VPN connections, Bluetooth, etc.), or any other suitable device hardware. The device may additionally include software, such as firmware (e.g. an operating system, boot sequence, etc.) and programs (e.g. aftermarket programs, applications, etc.). Examples of portable electronic devices 500 that may be used with this system include laptops, media players, tablets, gaming consoles, or any other suitable portable consumer device.

The system preferably further includes a power transmission mechanism that functions to transmit power from the power source 200 to the device 500. The power transmission mechanism preferably couples to the device and/or power source through a power port, (wherein friction between the connectors retains the power transmission mechanism position), but may alternatively couple to the components via a magnet, a clip, or any other suitable coupling mechanism. The power transmission mechanism may additionally include a chip that allows the device to identify the power transmission mechanism and/or the power source (e.g. how much power the device can pull, how long it may take). This chip may additionally change the state of a user indicator included in the power transmission mechanism, wherein the user indicator states may correlate with the state of charge (e.g. charging, not charging, etc.) and/or state of power production (ramping up, ramping down, etc.). The chip may additionally determine and/or calculate the signal indicative of the available power or determine and/or calculate the available power itself. The power transmission mechanism is preferably a power cable that removably couples the power source and the device, but may alternatively be a magnetic power transmitter, a circuit, a USB cable, or any other suitable power transmission mechanism. The power transmission mechanism preferably additionally includes a locking mechanism that prevents decoupling of the device and the power source while power is still being produced. Alternatively, the power transmission mechanism may alternatively not include such a mechanism and may be uncoupled from the device and/or power supply at any time, wherein the ending excess mechanisms of the power source preferably buffer the system against the ending excess.

The system preferably further includes a data transmission mechanism that functions to transmit data from the power source 200 to the device 500. The data transmission mechanism may further function to transmit data from the device to the power source. The data transmission mechanism is preferably the same component as the power transmission mechanism, but may alternatively be a portion of the power transmission mechanism, an auxiliary component to the power transmission mechanism, or a remote from the power transmission mechanism. The data transmission mechanism is preferably a data transmission cable, but may alternatively be a power line communication device (e.g. by using power line adapter sets), a Bluetooth transmitter and receiver pair, a radio transmitter and receiver pair, or any other component that enables the transfer of information. The data transmission mechanism preferably leverages components that the device already includes (e.g. a USB port, wireless connection, Bluetooth functionality, etc.). The data transmission mechanism is preferably a USB connector, but may alternatively be a FireWire connector, a HDMI connector, or any other connector capable of transferring data. The data transmission cable 442 is preferably bundled with the power output or input cable into a single cable, wherein the data connector preferably transfers power in addition to data. Examples of such data connectors include USB, FireWire and HDMI connectors, but other data connectors may alternatively be used. However, the data transmission cable 442 may alternatively be an independent cable, such that it is separate from the power transmission mechanism.

### 3. The Signal

The signal indicative of available power 203 is preferably generated at the power source 200, but may alternatively be generated at the power transmission mechanism or at the device 500. The signal is preferably a sensor measurement, but may alternatively be the a parameter indicative of available power, the available power itself (future or substantially instantaneous), or any other suitable signal indicative of available power as determined by the power source, power transmission mechanism, or device. The signal may be explicitly measured (e.g. with a sensor), implicitly measured (e.g. the device can only pull the instant available power), calculated, or be generated in any suitable manner. Preferably, available power is determined from the signal, but the signal may be the available power (e.g. wattage, a packet of information with the wattage measurement, a packet of information with the wattage and a timestamp, etc.) itself. The signal is preferably received by the device, and is preferably used by the device to prioritize the power distribution to device sub-circuits and/or functionalities. In one specific embodiment, the device adjusts the load (i.e. power drawn by the device) to match the available power as indicated by the signal.

The indicated available power may be the substantially instantaneous available power (current power output) and/or a future available power (future power output) for a given time interval.

The substantially instantaneous power available to the device (current power output) may be determined in a number of ways. In a first embodiment, the current power output is determined by the fuel cell system from a current (I) output measurement. In a second embodiment, the current power output is pre-calculated by the fuel cell system from the fuel ingress rate. In a third embodiment, the current power output is determined by the fuel cell system from the dead-end pressure, the rate of change in power production. In a fourth embodiment, the current power output is determined by the device as the maximum amount of power it can pull at that instant from the fuel cell system. In a fifth embodiment, the current power output is determined by the power transmission mechanism by the amount of power it is transferring. However, the substantially instantaneous available power may be determined in any other manner.

Likewise, the future available power (future power output) may be determined in a number of ways. In a first embodiment, the future power output is calculated by the fuel cell system from the fuel ingress rate into the fuel cell arrangement 220, wherein the future power output is for a time interval substantially equivalent to the amount of time required for the fuel to flow to the fuel cell and to be converted into electricity. In a second embodiment, the future power output is calculated by the fuel cell system from the fuel egress rate from the fuel storage 240, wherein the time interval is substantially equivalent to the time required for the fuel to flow from the fuel storage 240 to the fuel cell and to be converted into electricity. In a third embodiment, a fuel generator measurement and the desired time interval is compared to predetermined fuel generator characterization data (e.g. a table, graph, etc.), wherein the future power output for the time interval is determined from the data. Alternatively, the fuel cell system, power transmission mechanism, or device 500 may include a clock and memory, wherein the memory saves a chart or graph detailing the power production profile of the fuel cell system used to forecast the power production based on the time given by the timer. This chart or graph may be created from the power log of a previous use of the power source, and may be dynamically updated and/or created based on the current use of the power source. However, the future power output may be determined in any other manner.

### 4. Power Management Scheme

The device preferably operates on the exact amount of power supplied by the power source, and accommodates power shortages, such as the starting deficit 620, by selectively managing device functionalities based on a signal indicative of available power 203. In other words, the device power management scheme adaptively adjusts the device consumption to match the supplied and available power.

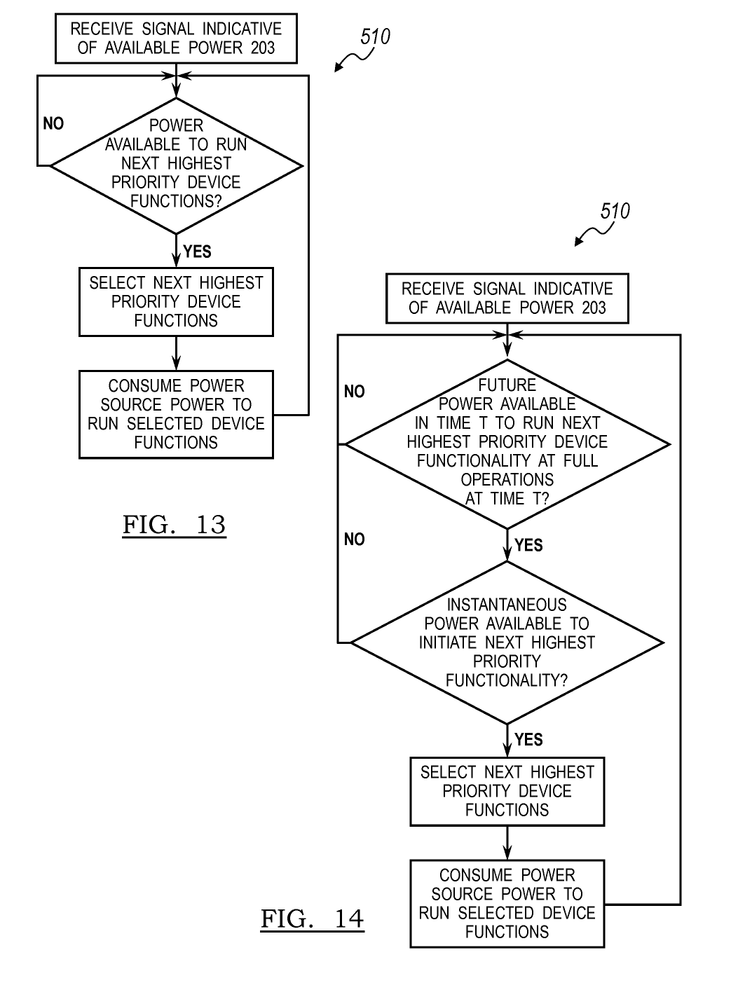

As shown in FIG. 13, this power management scheme 510 allows the device to be operational, albeit at a sub-optimal capacity, until enough power is available for the device to run at full capacity. The signaled available power received from the power source is preferably the future available power (future power output at a given time, wherein the data received includes a wattage and a timestamp or time interval), but may additionally/alternatively be the substantially instantaneous available power. The signal is preferably received from the power source, but may alternatively be generated by the device itself. As shown in FIG. 14, the device preferably manages power based on a combination of the future available power (future power output) and the substantially instantaneous available power (current power output), but may alternatively manage power based solely on future available power, instantaneous available power, or any other suitable parameter.

The power management scheme operates by adjusting the device power consumption to match the available power. In one preferred embodiment, the power management operated by determining power allocation of the available power between multiple device functionalities. Power allocation refers to the amount of power allocated to each of the device functionalities; some functions may be run at full capacity (i.e. provided the full amount of needed power), while others may be run at sub-optimal capacity (e.g. run at 10% of full performance), minimal capacity, or may not be run at all. Certain functionalities may also be limited until a powering event (e.g. available power surpasses a predetermined threshold, the user tries to utilize the functionality, etc.) occurs. For example, high-powered functionalities may not be supplied power until available power surpasses a predetermined threshold, or a given function may only run at a certain percentage of full operation until the user attempts to utilize the function.

Functionality selection is preferably based on the available power and functionality prioritization. Prioritization is preferably based on device priorities (e.g. for startup, operation, etc.), but may alternatively/additionally be based on user priorities (e.g. forgo powering an auxiliary drive in favor of running a program), be based on a weighted prioritization of both device and user priorities, or be based on any other suitable prioritization scheme. Functionalities are preferably prioritized first by their influence on device operability, then by their power consumption levels. For example, low-power functionalities that are required for device startup and basic operation (e.g. powering the CPU, powering RAM, initiating the bootup sequence etc.) preferably have the highest priority, while high-power functionalities that are substantially unnecessary for basic operation (e.g. powering the optical drive, running a media player, etc.) preferably have low priorities. Alternatively, functionalities may be selected based primarily on their power consumption levels. For example, an indicator light (e.g. an LED that indicates that the device is on and/or charging) may be selected in lieu of running a boot sequence, even though the boot sequence is a higher priority for device operation.

Functionality prioritization may also be affected by user preferences. For example, if the device determines (e.g. through repeated use) that a user typically opens a media player and watches a movie when the device is turned on, then the media player functionality may be ranked with a high priority. Prioritization may also be influenced by the device state. For example, if the device is powered off when the power source is coupled to the device, then the device may select the battery charging functionality, wherein the available power is used to charge the battery. Furthermore, functionality prioritization may be dynamically adjusted, wherein active user selection of a functionality preferably gives the user-selected functionality a higher prioritization (i.e. the device preferably selectively powers the user-selected functionality over other functionalities).

The device 500 may, based on both the substantially instantaneous received power and the future power estimation, preferentially run a high-power functionality. This preferably occurs when the future power output estimation indicates that enough power will be available for the device to power the high-power functionality. In this case, the device preferably initiates the high-power functionality with the small amount of power initially provided, preferably at sub-optimal performance. The functionality performance is preferably then ramped up as the instantaneous power or estimated power for the given time (e.g. through extrapolation from the future power output) increases.

The selected functionalities and the amount of power allocated to each functionality preferably changes as the available power changes, wherein the device dynamically reallocates power between multiple functionalities based on the available power. Reallocation preferably occurs whenever a change in available power is detected, but power allocation may alternatively be re-evaluated at a given frequency (e.g. every 10 milliseconds). However, power reallocation may alternatively be based on functionality reprioritization (e.g. from user interaction with the device), or on any suitable change in the system. Functionalities are preferably initiated and ramped up (provided more power) throughout device operation, but may alternatively be shut off or ramped down as well. Functionality selection is preferably dynamically determined by the device, but may alternatively be hard-coded into the device (e.g. the device has a set power prioritization list).

In a first embodiment of the power management scheme, the device determines the substantially instantaneous available power provided by the power source by determining the maximum amount of power it can pull from the power source. The device then selectively runs functionalities that, in total, require less than or substantially the amount of instantaneous available. The device periodically repeats this process (determining instantaneous power and selectively running functionalities). For example, the device may only run a basic startup/boot sequence (e.g. power the CPU and run the boot sequence, but not power the display) until enough power is received to run more power-consuming functionalities.

In a second embodiment of the power management scheme, the device runs at full capacity by supplementing the power available from the power source with on-board (device) battery power, wherein selection of supplementing and/or powering the device solely off the on-board battery is the selected device functionality. The device then preferably switches to running solely off the power source power, but may operate on battery power or a combination of both battery and power source power throughout the duration of operation. Alternatively, the device may select to always run the device off battery power and to only use the power source to charge the battery (selected functionality).

In a third embodiment of the power management scheme, as shown in FIG. 14, the device selectively powers functionalities based on both the substantially instantaneous available power and the future available power, wherein both are pieces of data received from the power source. Factoring in the future available power into the functionality selection allows the device to power functionalities that would otherwise remain unpowered. For example, the device may initiate a high power-consumption component (e.g. a graphics card) even though the current amount of power is unable to support full functionality of the component, because the estimated future power output indicates that the future amount of available power will be able to support full component functionality in a suitable amount of time. This is preferably used with functionalities (hardware and/or software) that have a hysteretic start-up and/or shut-down curve.

In a fourth embodiment of the power management scheme, the device switches from powering a high-priority functionality (e.g. a wireless module) to powering a less prioritized functionality (e.g. an optical drive) based on a user action (e.g. the user inserts a compact disk into the optical drive).

As a person skilled in the art will recognize from the previous detailed description and from the figures and claims, modifications and changes can be made to the power management scheme of the device without departing from the scope of this invention.

The system preferably additionally buffers against operational variation. The device battery preferably buffers fluctuations in provided power, supplementing and absorbing power as necessary. Alternatively the device may buffer against the operational variation by adjusting the state of various functionalities. For example, the device may increase display brightness to burn off excess power, or dim display brightness to accommodate for low power provision. Alternatively, the auxiliary battery within the power source or any other suitable mechanism may buffer the operational variation.

The system preferably further buffers against ending excess. The ending excess is preferably absorbed by the device battery. To prevent battery 420 overcharging, the device battery 504 is preferably kept at a less-than-full state (e.g. 98% full) during the operation, wherein the excess energy charges the battery 420 to a full state after a stop signal is received. Alternatively, the device may selectively manage functionalities to consume the ending excess power. This may include providing more power to functionalities in operation (e.g. increasing the brightness of a display, providing more power to auxiliary circuits), or may include initiating a functionality previously not in operation (e.g. turning on a media player and playing a power-consuming video). The device may alternatively include resistive elements that transform the excess power into heat.

As a person skilled in the art will recognize from the previous detailed description, the aforementioned system power management schemes may be used independently or in combination in the power source. Additionally, other means and methods of that enable the power source and/or device to accommodate for the starting deficit 620, ending excess 640 and/or operation variation 660 may be used without departing from the scope of this invention.

As a person skilled in the art will recognize from the previous detailed description and from the figures and claims, modifications and changes can be made to the preferred embodiments of the invention without departing from the scope of this invention defined in the following claims.

We claim:

1. A system comprising:
a fuel cell system configured to produce power from a fuel, the fuel cell system comprising:
a fuel cell arrangement fueled by a fuel supply; and
a sensor configured to generate a signal indicative of available power; and
a device configured to receive the power as the power is produced, the device comprising:
a first processor configured to manage a device functionality to match the available power.

2. The system of claim 1, wherein the signal is indicative of substantially instantaneous available power.

3. The system of claim 2, wherein the signal is further indicative of a future available power.

4. The system of claim 3, wherein the fuel cell system further comprises a second processor configured to determine the future available power from the signal.

5. The system of claim 3, wherein the first processor is further configured to dynamically reallocate power between a first and a second device functionality based on the instantaneous and future available power.

6. The system of claim 1, wherein the sensor measures a parameter of the fuel cell arrangement.

7. The system of claim 6, wherein the sensor measures the dead end pressure of the fuel cell arrangement.

8. The system of claim 1, wherein the fuel cell system is configured to adjust power production in response to power requested by the device.

9. The system of claim 8, wherein the fuel supply is a fuel generator, wherein the fuel cell system is configured to adjust power production by adjusting the rate of fuel generation.

10. The system of claim 9, wherein the fuel generator is configured to generate fuel by thermolysing aluminum hydride, wherein the fuel cell system is configured to adjust the rate of fuel generation by adjusting the temperature to which the aluminum hydride is heated.

11. system of claim 1, wherein the system further includes a power transfer mechanism configured to transfer produced power from the fuel cell system to the device.

12. The system of claim 11, wherein the power transfer mechanism is further configured to transfer a first set of information, indicative of available power, from the fuel cell system to the device.

13. The system of claim 12, wherein the first set of information is future available power and a time interval, wherein the future available power is determined from the signal.

14. The system of claim 12, wherein the power transfer mechanism is further configured to transmit a second set of information from the device to the fuel cell system.

15. The system of claim 15, wherein the second set of information is power requested by the device.

16. The system of claim 1, wherein the power transfer mechanism is a power cable.

17. The system of claim 1, wherein the device functionality is the startup sequence.

18. The system of claim 1, wherein the fuel cell arrangement is a fuel cell stack.

19. A system for accommodating for power production lag, the system comprising:
a fuel cell system configured to produce power, the fuel cell system comprising:
a fuel cell arrangement fueled by a fuel supply;
a sensor configured to measure a fuel cell system parameter;
a first processor configured to determine a future power output from the parameter measurement;
a device, remote from the fuel cell system, the device comprising:
a second processor configured to manage a device functionality based on the future power output and a substantially instantaneous available power from the fuel cell system.

20. The system of claim 19, wherein the system further comprises a data transfer mechanism configured to transfer a first set of information from the fuel cell system to the device.

21. The system of claim 20, wherein the first set of information comprises the future power output.

22. The system of claim 20, wherein the data transfer mechanism is further configured to transfer a requested power input from the device to the fuel cell system.

23. The system of claim 22, wherein the first processor is configured to adjust, based on the requested power input, the power production by adjusting a fuel cell system parameter.

24. The system of claim 23, wherein power production is adjusted by adjusting the fuel flow rate to the fuel cell arrangement.

25. The system of claim 24, wherein the fuel supply is a fuel generator configured to generate fuel from a reaction between a first and a second reactant, wherein the fuel flow rate is adjusted by adjusting the amount of the first reactant available for reaction.

26. The system of claim 25, wherein the first reactant is heat and the second reactant is a compound that thermolyses to produce fuel.

27. The system of claim 20, wherein the data transfer mechanism is configured to transfer power from the fuel cell system to the device.

28. The system of claim 27, wherein the data transfer mechanism is a power cable.

29. The system of claim 19, wherein the second processor dynamically allocates the power between a first and a second functionality based on the future power output and the substantially instantaneous available power.

30. system of claim 19, wherein the sensor measures the dead-end pressure of the fuel cell arrangement.

31. The system of claim 19, wherein the fuel cell arrangement is a fuel cell stack.

32. The system of claim 19, wherein the device is a portable consumer device.
